(19) United States
(12) Patent Application Publication
(10) Pub. No.: US 2024/0280761 A1
(43) Pub. Date: Aug. 22, 2024

(54) FIBER OPTIC ADAPTER

(71) Applicant: Senko Advanced Components, Inc., Hudson, MA (US)

(72) Inventor: Yim WONG, Kowloon (HK)

(73) Assignee: Senko Advanced Components, Inc., Hudson, MA (US)

(21) Appl. No.: 18/435,823

(22) Filed: Feb. 7, 2024

Related U.S. Application Data
(60) Provisional application No. 63/485,296, filed on Feb. 16, 2023.

(51) Int. Cl. G02B 6/38

(52) U.S. Cl. CPC G02B 6/3831; G02B 6/3802; G02B 6/3825; G02B 6/3893

(57) ABSTRACT

A fiber optic adapter includes an adapter housing defining a connector port for mating with a fiber optic connector in either of two connector polarity orientations. A polarity cap is releasably securable to the adapter housing in either of two adapter polarity orientations, each of which only permits insertion of the connector in one respective connector polarity orientation. The changing polarity of the adapter is facilitated by removing the polarity cap from the adapter housing, inverting the polarity cap, and reinstalling the inverted polarity cap.

### CROSS-REFERENCE TO RELATED APPLICATION

This application claims priority to U.S. Provisional Patent Application No. 63/485,296, filed Feb. 16, 2023, which is hereby incorporated by reference in its entirety.

### FIELD

The present disclosure relates to a fiber optic adapter with features adapted to receive the fiber optic connectors in different polarities.

### BACKGROUND

Fiber optic adapters mate with fiber optic connectors in order to align one or more optical fibers held by each connector with another optical fiber or optical component, thereby making an optical connection. However, in an improper system design, when duplex fiber optic connectors are used, polarity reversal is required to reverse the fiber optic ferrule orientation in relation to the adapter housing to establish the optical connection. However, this is not feasible when the fiber optic adapter only allows the fiber optic connector to be inserted in one orientation but prevents it from being inserted when it is inverted. Therefore, a fiber optic adapter that allows the fiber optic connector to be inserted in both polarities.

### SUMMARY

In one aspect, a fiber optic adapter comprises an adapter housing having a first end portion and a second end portion spaced apart along a longitudinal axis. The adapter housing defines at least one reversible polarity connector port opening through the first end portion of the adapter housing for mating with a fiber optic connector in either of a first connector polarity orientation or a second connector polarity orientation. A polarity cap is releasably securable to the first end portion of the adapter housing in either of a first adapter polarity orientation or a second adapter polarity orientation. When the polarity cap is secured to the first end portion of the adapter housing in the first adapter polarity orientation, the polarity cap permits the fiber optic connector to mate with the reversible polarity connector port in the first connector polarity orientation but blocks the fiber optic connector from mating with the reversible polarity connector port in the second connector polarity orientation. When the polarity cap is secured to the first end portion of the adapter housing in the second adapter polarity orientation, the polarity cap permits the fiber optic connector to mate with the reversible polarity connector port in the second connector polarity orientation but blocks the fiber optic connector from mating with the reversible polarity connector port in the first connector polarity orientation.

In another aspect, a cap removal tool for removing a polarity cap from an end portion of an adapter housing of a fiber optic adapter containing at least one reversible polarity port comprises a tool body having a top portion, a bottom portion, and opposite first and second side portions. At least one hook arm extends longitudinally from one of the top portion and the bottom portion of the tool body. The hook arm has a free end portion defining a removal hook configured to hook onto an inward facing internal ledge of the polarity cap. First and second actuation arms extend longitudinally from the first and second side portions of the tool body. The first and second actuation arms are configured for insertion into channels between the polarity cap and side walls of the adapter housing whereby the actuation elements are configured to bend bendable catches located within the channels to unlatch the polarity cap from the adapter housing.

In another aspect, a method of changing polarity of a reversible polarity port of a fiber optic adapter comprises removing a polarity cap from a first end portion of an adapter housing, inverting the polarity cap to an inverted orientation in relation to the adapter housing, and installing the polarity cap on the first end portion of the adapter housing in the inverted orientation.

Other aspects and features will be apparent hereinafter.

### BRIEF DESCRIPTION OF THE DRAWINGS

FIG. 1A is a perspective of a fiber optic adapter showing a polarity cap thereof separated from an adapter housing;

FIG. 1B is a perspective of the adapter in which the polarity cap is installed on the adapter housing;

FIG. 2 is a cross-sectional perspective of the adapter;

FIG. 3 is a cross section of the adapter;

FIG. 4A is an elevation of the polarity cap;

FIG. 4B is a perspective of the polarity cap;

FIG. 4C is another perspective of the polarity cap;

FIG. 4D is another elevation of the polarity cap;

FIG. 4E is another elevation of the polarity cap;

FIG. 4F is a cross section taken in the plane of line 4F-4F of FIG. 4D;

FIG. 4G is a cross section taken in the plane of line 4G-4G of FIG. 4E;

FIG. 4H is another perspective of the polarity cap;

FIG. 4I is a top plan view of the polarity cap;

FIG. 4J is a bottom plan view of the polarity cap;

FIG. 5 is a perspective of a fiber optic connector;

FIG. 6 is an elevation of the fiber optic connector;

FIG. 7A is a perspective of the adapter showing the polarity cap separated from the adapter housing in a top-up orientation;

FIG. 7B is a perspective similar to FIG. 7A but showing the polarity cap in a bottom-up orientation;

FIG. 7C is a perspective of the adapter in which the polarity cap is installed on the adapter housing in the bottom-up orientation;

FIG. 8A is a perspective showing the connector approaching a reversible polarity port of the adapter;

FIG. 8B is a perspective showing the connector mated with the reversible polarity port of the adapter;

FIG. 9 is a cross section of the adapter with the connector mated with the reversible polarity port;

FIG. 10A is a cross section of the adapter showing the polarity cap separated from the adapter housing;

FIG. 10B is a cross section similar to FIG. 10 but showing the polarity cap installed on the adapter housing;

FIG. 11 is a perspective of a cap removal tool;

FIG. 12 is an exploded perspective of the cap removal tool;

FIG. 13 is a cross section of the cap removal tool;

FIG. 14 is a perspective showing the cap removal tool approaching the adapter;

FIG. 15 is a perspective showing the cap removal tool operatively engaged with the adapter;

FIG. 16A is a cross section of the scene depicted in FIG. 15;

FIG. 16B is a cross-sectional perspective of the scene depicted in FIG. 15;

FIG. 16C is another cross section of the scene depicted in FIG. 15;

FIG. 17A is a perspective showing the cap removal tool and the adapter after the cap removal tool has removed the polarity cap from the adapter housing;

FIG. 17B is a cross section of the scene depicted in FIG. 17A;

FIG. 18A is a perspective showing the cap removal tool and the polarity cap wherein hook arms of the cap removal tool are depressed;

FIG. 18B is a cross section of the scene depicted in FIG. 18A;

FIG. 19A is a perspective similar to FIG. 18A but showing the cap removal tool separated from the polarity cap;

FIG. 19B is a cross section of the scene depicted in FIG. 19A;

FIG. 20A is a perspective of the adapter housing;

FIG. 20B is another perspective of the adapter housing;

FIG. 21A is a perspective of the polarity cap;

FIG. 21B is another perspective of the polarity cap;

FIG. 22A is a perspective of the adapter;

FIG. 22B is another perspective of the adapter;

FIG. 23A is a cross-sectional perspective of the adapter engaged with the cap removal tool;

FIG. 23B is a cross section of the adapter engaged with the cap removal tool;

FIG. 24A is a cross-sectional perspective of another embodiment of an adapter engaged with the cap removal tool;

FIG. 24B is a cross section of the adapter of FIG. 24A engaged with the cap removal tool;

FIG. 25A is a cross-sectional perspective of another embodiment of an adapter engaged with the cap removal tool;

FIG. 25B is a cross section of the adapter of FIG. 25A engaged with the cap removal tool;

FIG. 26A is a cross-sectional perspective of another embodiment of an adapter engaged with the cap removal tool;

FIG. 26B is a cross section of the adapter of FIG. 26A engaged with the cap removal tool;

FIG. 27A is a cross-sectional perspective of another embodiment of an adapter engaged with the cap removal tool; and

FIG. 27B is a cross section of the adapter of FIG. 27A engaged with the cap removal tool.

Corresponding reference characters indicate corresponding parts throughout the drawings.

### DETAILED DESCRIPTION

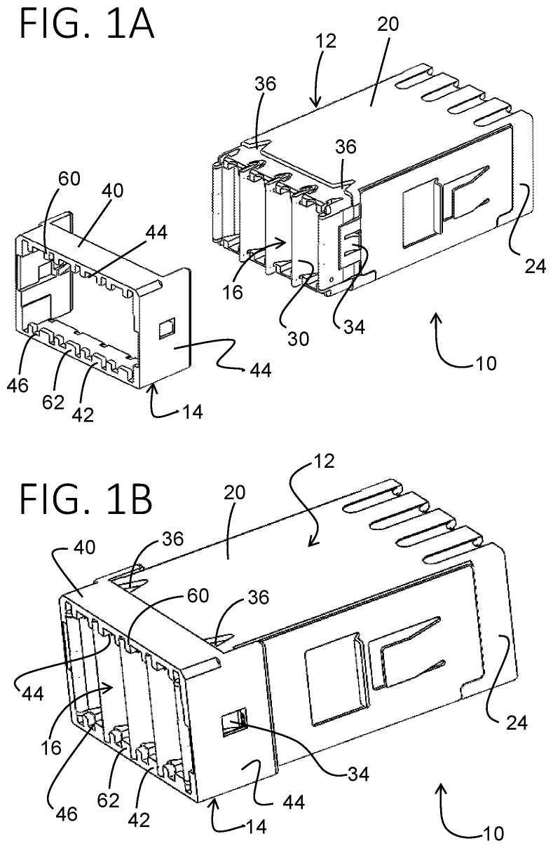

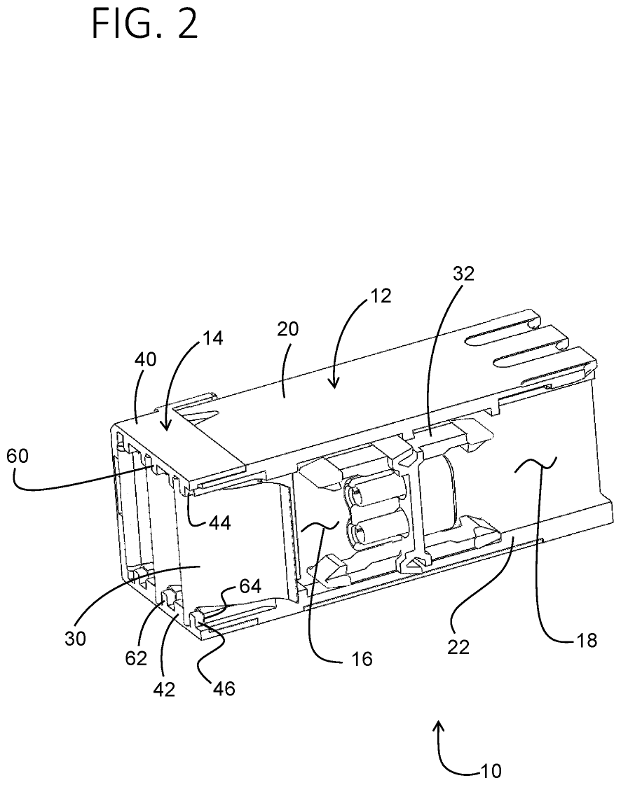

Referring to FIGS. 1A-3 and 7A-7C, an exemplary embodiment of a fiber optic adapter in accordance with the present disclosure is generally indicated at reference number 10. The fiber optic adapter 10 comprises an adapter housing 12 and a polarity cap 14 that can be selectively secured to the adapter housing in two different orientations to switch the polarity of one or more reversible polarity ports 16 of the adapter.

In the illustrated embodiment, the adapter 10 is an inline adapter configured for making optical connections between fiber optic connectors inserted into opposite ends of the adapter. In other embodiments, the adapter can comprise a receptacle with one or more ports on only one end for mating with fiber optic connectors, e.g., the optical receptacle of a transceiver. In the illustrated embodiment, the adapter 10 is a four-port (quad) adapter configured defining four reversible polarity ports 16 at one end and four fixed polarity ports 18 at the opposite end. Certain embodiments of adapters in the scope of this disclosure have at least three reversible polarity connector ports arranged side-by-side in the adapter housing. It will be understood, however, that more or fewer ports (e.g., one or more ports) may be included in adapters within the scope of the present disclosure.

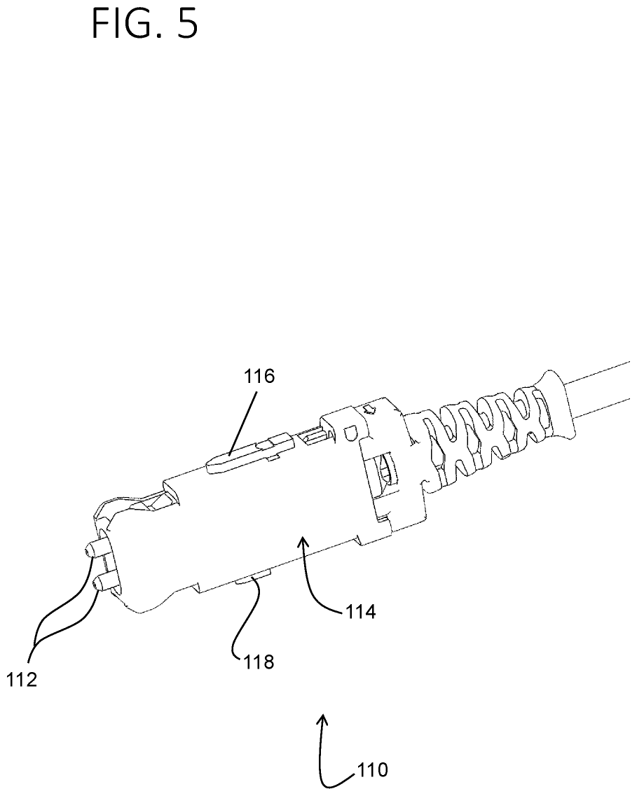

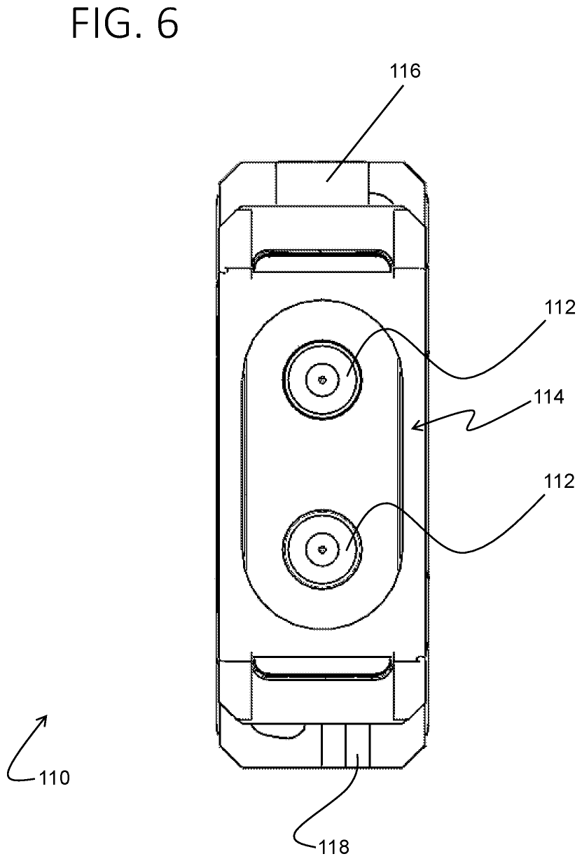

In certain exemplary embodiments, the adapter 10 is a very small form factor (VSFF) adapter configured for mating with VSFF connectors, such as the SN connector (available from the Applicant), the SN-MT connector (also available from the Applicant), the MDC connector (available from US Conec of Hickory, North Carolina), or the MMC connector (also available from US Conec). Such VSFF connectors typically comprise narrow top/bottom walls and comparatively tall side walls with polarity key features disposed on one or both of the narrow top/bottom walls. An exemplary VSFF connector 110 is depicted in FIGS. 5 and 6. The connector 110 is an SN connector of the type comprising two single fiber-ferrules 112 received in a VSFF connector housing 114. As shown, the SN connector 110 comprises a first polarity key 116 located on a nominal top side of the connector and a second polarity key 118 located on a nominal bottom side of the connector. As explained more fully below, depending on the polarity selected for the reversible polarity ports 16, the SN connector 110 can be inserted into a reversible port in either a first “top-up” orientation (in which the nominal top side and key 116 are on top of the connector in relation to the orientation of components as shown in the drawings) or a second “bottom-up” orientation (in which the nominal bottom side and key 118 are on top of the connector in relation to the orientation of components as shown in the drawings. In this disclosure, “nominal top” and “nominal bottom” are used to indicate walls of a connector 110 or polarity cap 14 that are switchable from top to bottom in accordance with the polarity change features disclosed herein, whereas directional terms (e.g., “top,” “bottom,” “upper,” “lower,” etc.) not preceded by the word “nominal” refer to non-switchable components (e.g., features of the adapter 10 along the fixed polarity ports 18) and the orientations of such components as shown in the drawings. It is to be further understood that the orientation of components in the drawings is non-limiting. “Top” and “bottom” features in this disclosure may be reversed or rotated to be on the lateral sides of components in the field, depending on installation requirements.

The first polarity key 116 is relatively wide and centered along the width of the connector. The second polarity key 118 is narrower and offset from center along the width of the connector. The SN connector 110 is used for illustrative purposes only. The disclosure is not limited to connectors with polarity keys 116, 118 on top and bottom sides. The principles of this disclosure could be adapted for use with connectors with polarizing features on any one or more sides of the connector.

Referring again to FIGS. 1A-3, the adapter housing 12 has a first end portion and a second end portion spaced apart along a longitudinal axis. The reversible polarity ports 16 open through the first end portion of the adapter housing 12, and the fixed polarity ports 18 open through the second end portion of the adapter housing. The adapter housing 12 has a top wall 20 and a bottom wall 22, each extending along the longitudinal axis from the first end portion to the second end portion. Additionally, the adapter housing 12 comprises opposite first and second side walls 24, each extending from the first end portion to the second end portion of adapter housing.

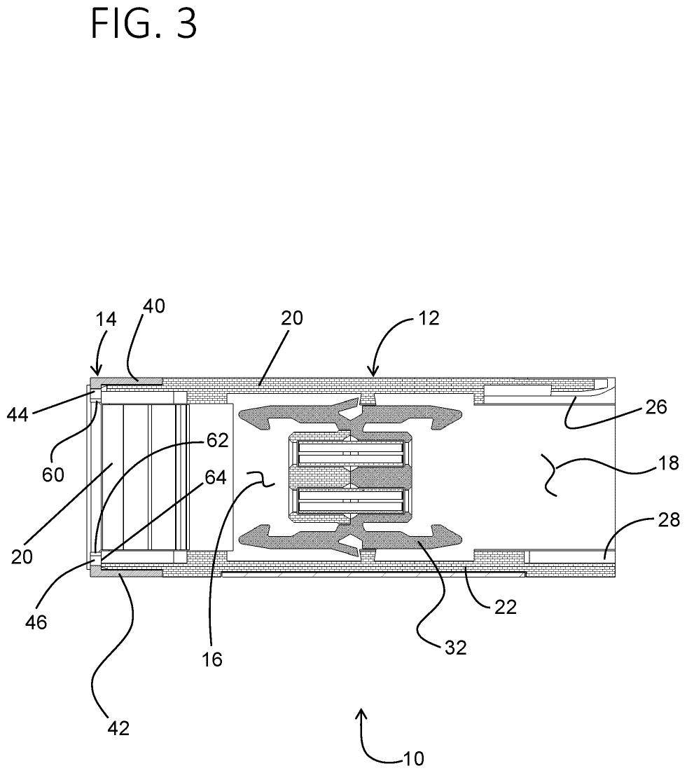

At each fixed polarity port 18, the top wall 20 defines a first keyway 26 (FIG. 3) configured to accept the first polarity key 116 of a connector 110 and the bottom wall 22 defines a second polarity keyway 28 configured to accept the second polarity key 118 of the connector. Thus, the keyways 26, 28 assign the polarity of the fixed polarity ports 18. The connector 110 can only be inserted into the fixed polarity ports 18 in a first (top-up) polarity orientation in which the first polarity key 116 is aligned with the first keyway 26 and the second polarity key 118 is aligned with the second keyway 28. If the connector 110 is inverted, the bottom wall 22 of the adapter housing 12 will interfere with the first polarity key 116 and block insertion of the connector. The top and bottom walls 20, 22 of the adapter housing 12 do not define polarity keyways in the reversible polarity ports 16 (there may be internal groove structures on the top and bottom adapter walls within the reversible polarity ports 16, but such groove structures, if present, can accept either polarity key 116, 118 of the connector 110). Instead of forming the polarizing structure for the reversible polarity ports 16 inside the adapter housing 12, as will be explained in further detail below, the polarity cap 14 defines the polarity keyways for the reversible polarity ports 16, which facilitates switching the polarity of the reversible polarity ports so that connectors 110 can be inserted into the reversible polarity ports in either the first (top-up) polarity orientation or second (bottom-up) polarity orientation.

Each fixed polarity port 18 aligns with a respective reversible polarity port 16 so that the adapter 10 will hold and align opposing connectors 110 inserted into the aligned pair of ports 16, 18 so that an optical connection is made between the two connectors. As is conventional with SN adapters, between each aligned pair of ports 16, 18, the adapter housing 12 mounts an adapter latch 32 configured for latching with the latch recesses of the SN connectors 110 inserted into the respective ports 16, 18. When an adapter latch 32 latches with two opposing SN connectors 110, the adapter 10 holds and aligns the two connectors so that an optical connection is made between them inside the adapter.

In the illustrated embodiment, the adapter 10 comprises a shutter system 30 disposed on the first end portion of the adapter housing 12. It will be understood, however, that the principles of this disclosure do not require a shutter system.

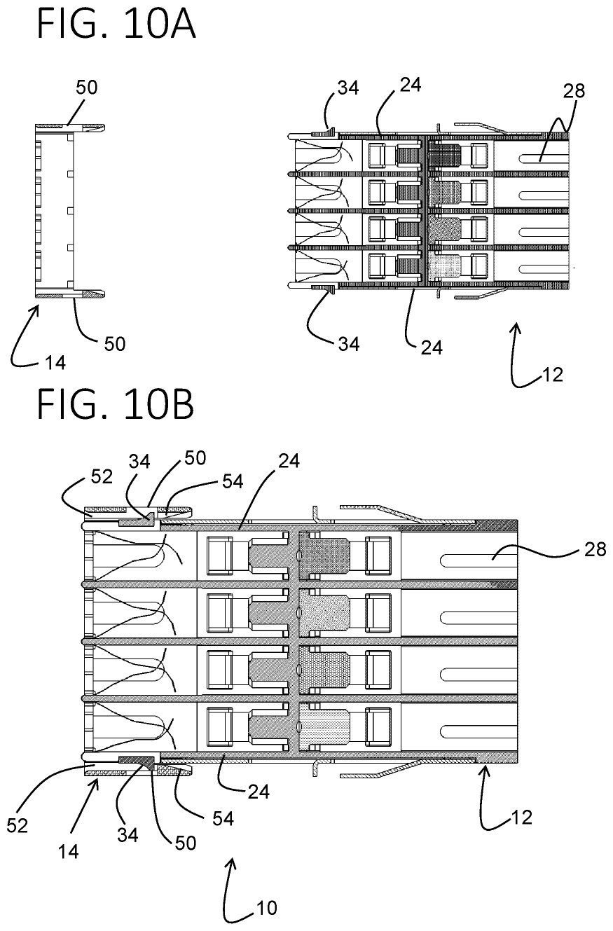

Referring to FIG. 1A, each side wall 24 of the adapter housing 12 comprises a resiliently bendable catch 34 adjacent the first end portion of the adapter housing. Only one side wall 24 is visible in FIG. 1A, but a catch 34 of the same size, shape, and longitudinal position is also formed on the opposite side wall 24 (see FIG. 10A). As will be explained in further detail below, the bendable catches 34 (broadly, latching features) are configured for releasably securing the polarity cap 14 to the first end portion of the adapter housing 12 in either a first adapter polarity orientation or a second adapter polarity orientation.

Referring to FIGS. 1A-1B, the adapter top wall 20 comprises one or more indicator formations 36 that are located so as to be visible from the first end portion side of the adapter 10 when the polarity cap 14 is secured to the adapter housing 12. The indicator formations 36 are intended to provide an indication that the wall on which they are formed is the top wall 20 of the adapter housing 12, which in turn means that it is the wall on which the first polarity keyways 26 are located inside the fixed polarity ports 18. The bottom wall 22 is devoid of similar external indicator formations so that the top wall 20 is clearly distinguishable from the bottom wall based on the presence of the indicator formations 36. Thus, broadly, the adapter top wall 20 and the adapter bottom wall 22 have different external shapes.

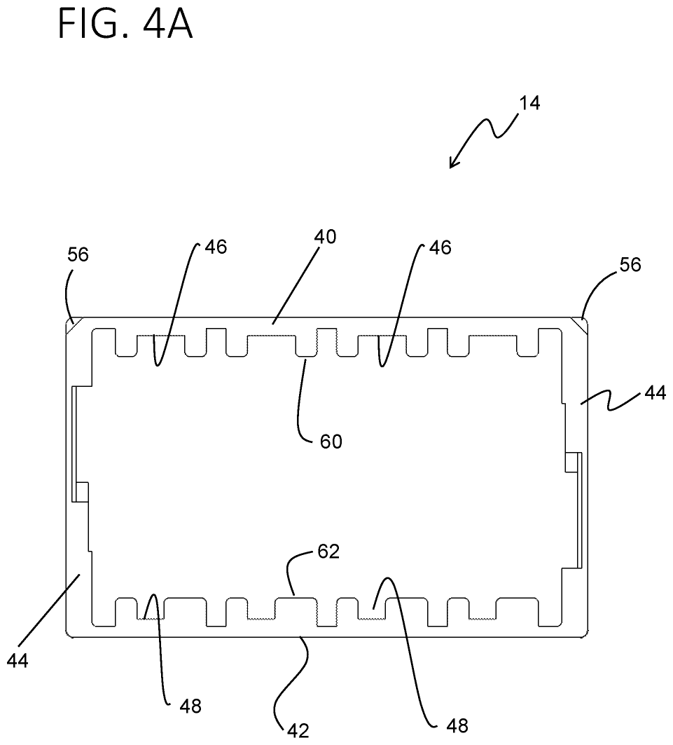

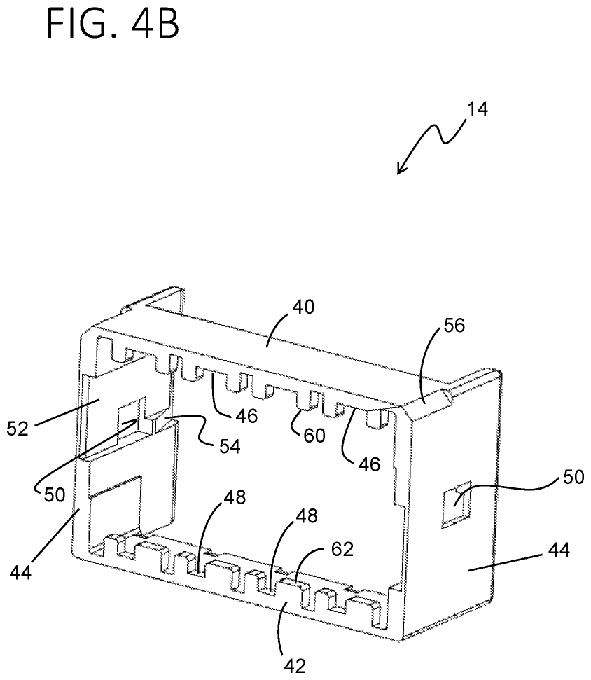

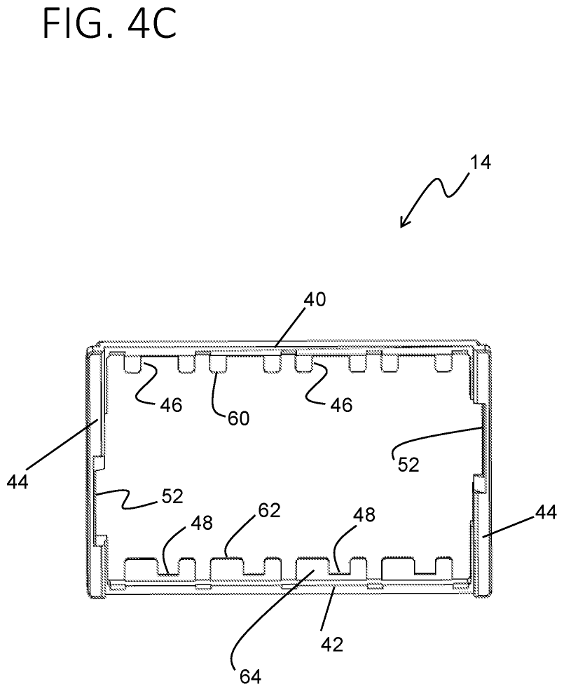

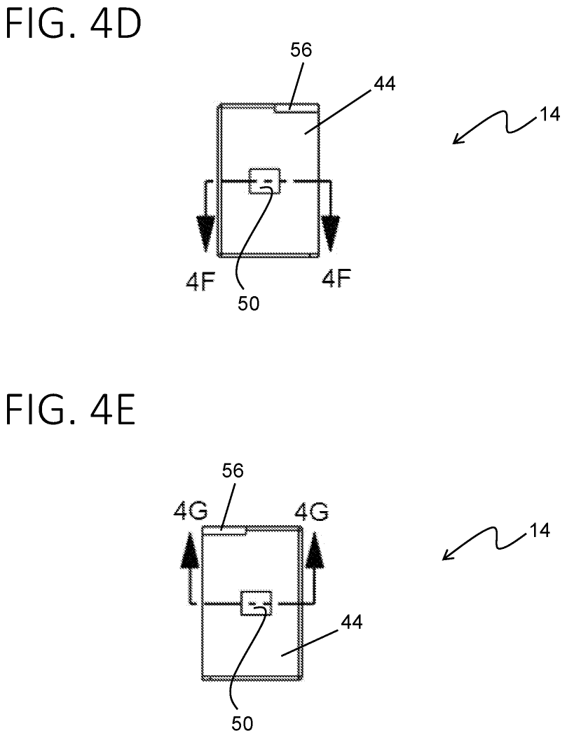

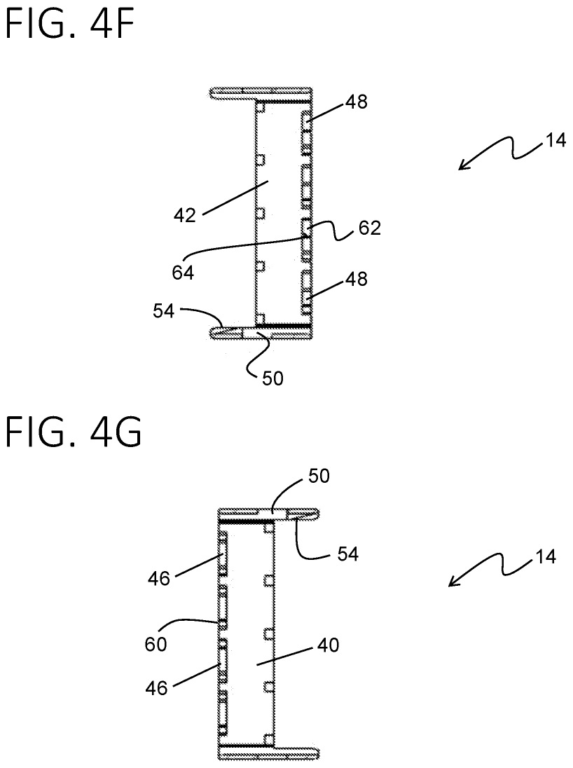

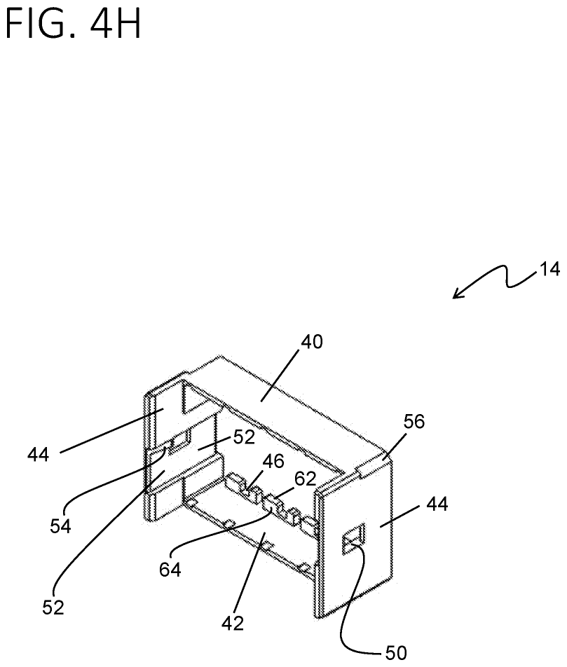

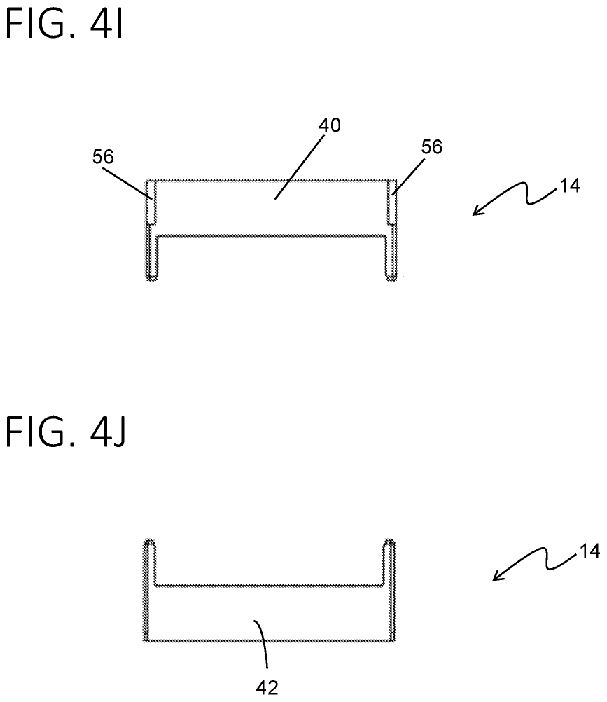

Referring to FIGS. 4A-4J, the illustrated polarity cap 14 comprises a rectangular shroud that is sized and arranged for fitting onto the first end portion of the adapter housing 12. The polarity cap 14 comprises a nominal top wall 40, a nominal bottom wall 42, and a height extending from the nominal bottom wall to the nominal top + wall. The polarity cap 14 comprises opposite first and second cap side walls 44 extending between the nominal top wall 40 and the nominal bottom wall. As can be seen in FIGS. 1B-3, when the polarity cap 14 is fitted onto the first end portion of the adapter housing 14, the first end portion of the adapter housing is surrounded by the walls 40, 42, 44 of the polarity cap. An outer end portion of the polarity cap 14 is positioned outboard of the first end portion of the adapter housing 12.

The nominal top wall 40 and the nominal bottom wall 42 have different internal shapes in order to assign the polarity of the polarity cap 14. More particularly, the nominal top wall 40 wall defines a first keyway 46 for each reversible polarity connector port 16 and the nominal bottom wall 12 defines a second keyway 48 for each reversible polarity connector port. In the illustrated embodiment, which is configured for use with the SN connectors 110, each first keyway 46 (like the first keyways 26 of the fixed polarity ports 18) is relatively wide and configured to be centered along the width of the connector port 16. Each second keyway 48 (like the second keyways of the fixed polarity ports 18) is narrower and configured to be offset from center in relation to the respective reversible polarity port 16. More broadly, each first keyway 46 may differ from the respective second keyway 48 in at least one of (i) width and (ii) widthwise position.

In the illustrated embodiment, the polarity cap 14 comprises in-turned lips 60, 62 at the outboard end portions of the nominal top and bottom cap walls 40, 42, and the polarity keyways 46, 48 are formed on the in-turned lips. As explained more fully below, at least one of the lips 60, 62 defines an inward facing internal ledge 64 configured to operatively engage a removal hook of a cap removal tool so that the cap removal tool can pull the cap off of the adapter housing via the removal hook.

Each of the first and second cap side walls 44 defines a respective latch recess 50 (broadly, a latch feature) for latching with bendable catches 34 of the adapter housing 12 to secure the polarity cap 14 to the first end portion of the adapter housing in either of a first adapter polarity orientation or a second adapter polarity orientation. Internally, each side wall 44 comprises a longitudinal groove 52 that crosses the latch recess. Within each groove 52 is a ramp structure 54 located longitudinally inboard of the respective latch recess 50. As will be explained in further detail below, the latch recesses 50, longitudinal grooves 52, and ramp structures 54 are configured to facilitate handheld installation of the polarity cap 14 onto the first end portion of the adapter housing 12 and tool-driven removal of the polarity cap 14 from the first end portion of the adapter housing.

The nominal top wall 40 comprises one or more indicator formations 56 that are not present on the bottom wall 42 (broadly, the nominal top wall and the nominal bottom wall have different external shapes). The indicator formations 56 are intended to provide a clear indication that the wall on which they are formed is the nominal top wall 40 of the of the polarity cap 14, which in this case is the wall that has polarity keyways 46 that correspond in size, shape, and position with the polarity keyways 26 of the adapter top wall 20 (e.g., polarity keyways that mate with the first polarity keys 116 of the connectors 110).

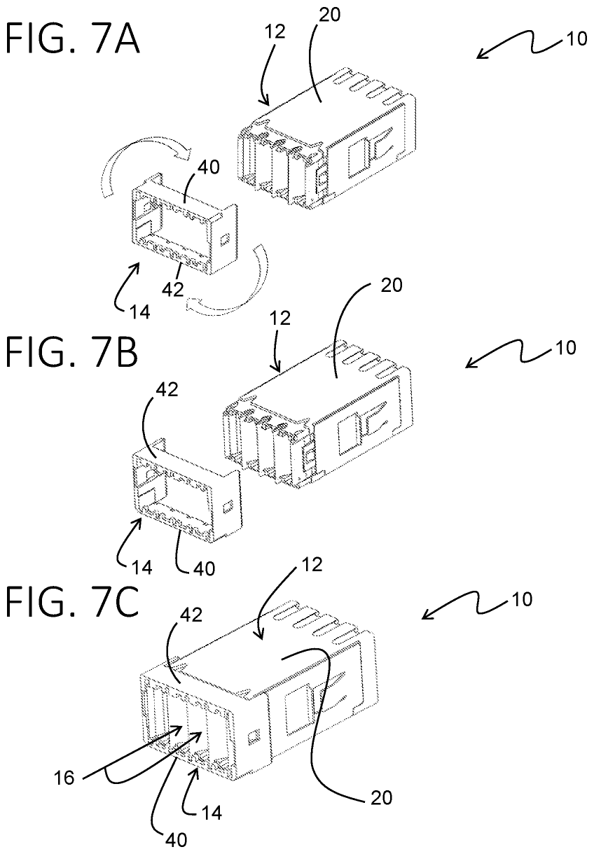

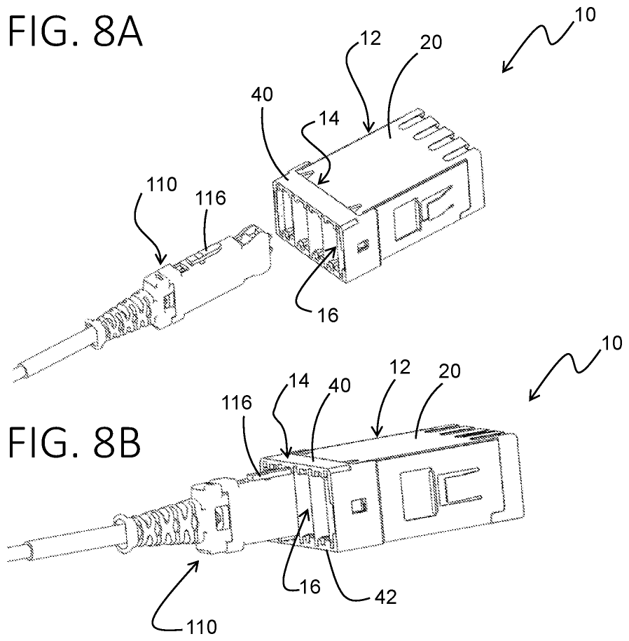

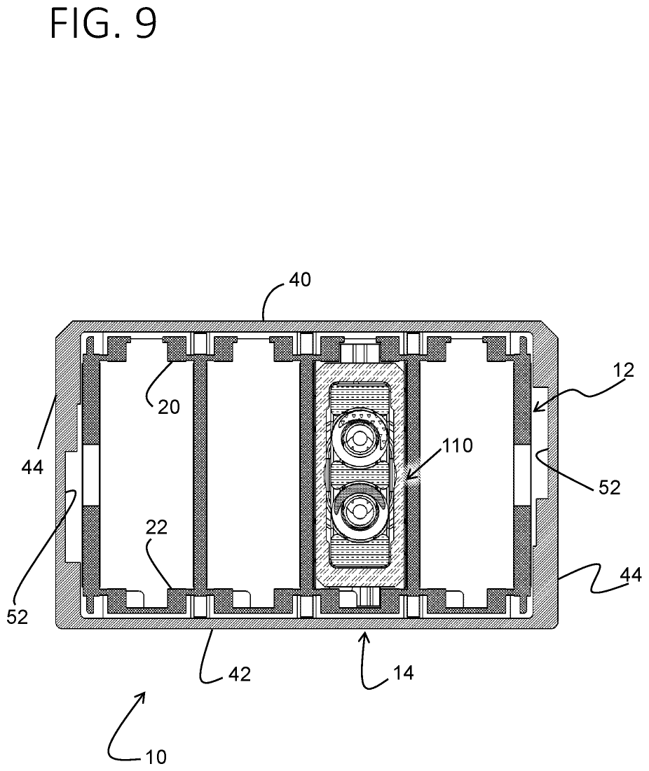

Referring to FIGS. 7A-7C, the polarity cap 14 is releasably securable to the first end portion of the adapter housing 12 in either of a first adapter polarity orientation (in which the nominal top wall 40 of the polarity cap is disposed on the top wall 20 of the adapter housing 12, e.g., a “top-up” orientation) or a second adapter polarity orientation (in which the nominal bottom wall 42 of the polarity cap is disposed on the top wall 20 of the adapter housing 12, e.g., a “bottom-up” orientation). FIGS. 8A-9 show the adapter 10 when the polarity cap 14 is secured to the adapter housing 12 in the first adapter polarity orientation (top-up). In this adapter configuration, the polarity cap 14 permits the fiber optic connector 110 to mate with the reversible polarity connector port 16 in the first connector polarity orientation (top-up) but blocks the fiber optic connector from mating with the reversible polarity connector port in the second connector polarity orientation (bottom-up). FIG. 7C depicts the adapter 10 when the polarity cap 14 is secured to the first end portion of the adapter housing 12 in the second adapter polarity orientation (bottom-up). In this adapter configuration, the polarity cap 14 permits the fiber optic connector 110 (not shown in FIG. 7C) to mate with the reversible polarity connector port 16 in the second connector polarity orientation (bottom-up) but blocks the fiber optic connector from mating with the reversible polarity connector port in the first connector polarity orientation (top-up). In practice, the polarity cap may be color coded, e.g., using different colors to indicate different orientations.

Since the illustrated adapter housing 12 has fixed polarity ports 18 opposite the reversible polarity ports, securing the polarity cap 14 to the first end portion of the adapter housing 12 in the first adapter polarity orientation (top-up) configures the fiber optic adapter 10 in a “first-first” polarity configuration wherein the fiber optic adapter is configured to make an optical connection between a first fiber optic connector 110 mated with a fixed polarity connector port 18 in the first connector polarity orientation (top-up) and a second fiber optic connector mated 110 with a reversible polarity connector port 16 in the first connector polarity orientation (top-up). By contrast, securing the polarity cap 14 to the first end portion of the adapter housing 12 in the second polarity orientation (bottom-up) configures the fiber optic adapter 10 in a “first-second” polarity configuration wherein the fiber optic adapter is configured to make an optical connection between a first fiber optic connector 110 mated with a fixed polarity connector port 18 in the first connector polarity orientation (top-up) and a second fiber optic connector mated with each reversible polarity connector port in the second connector polarity orientation.

Referring to FIGS. 10A-10B, an exemplary mechanism by which the polarity cap 14 releasably attaches to the adapter housing 12 will now be described in greater detail, but it will be understood that this disclosure is not limited to any particular type of releasable attachment mechanism. In either selected polarity orientation (either top-up or bottom-up), when the polarity cap 14 is loaded onto the adapter housing 12, the bendable catches 34 snap into the latch recesses 50. More particularly, as the polarity cap 14 is loaded onto the adapter housing 12, the ramp structures 54 depress the latch arms 34 inward until the ramp structures clear the latch arms, at which point, the latch arms snap back outward to latch with the latch recesses 50.

When the polarity cap 14 is secured to the first end portion of the adapter housing 12 in either of the first adapter polarity orientation and the second adapter polarity orientation, the grooves 52 in the cap side walls 44 define channels alongside each of the first and second adapter side walls 24. Each bendable catch 34 extends laterally outward across the channel formed by a groove 52 such that it latches with the respective latch recess 50 outboard of the channel. As explained more fully below, the channels formed by grooves 52 are sized and arranged to accept actuation elements of a cap removal tool that engage bendable catches 34 within the channels to bend the bendable catches and unlatch the polarity cap from the adapter housing.

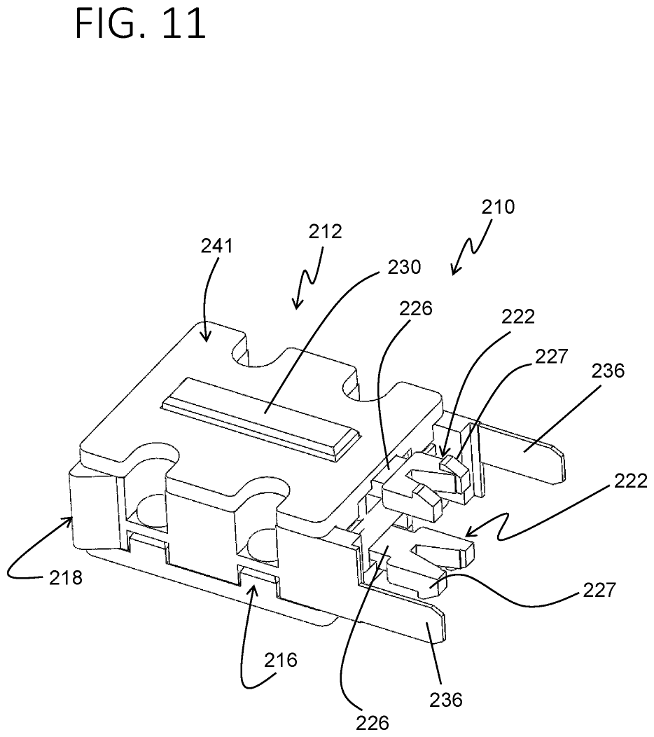

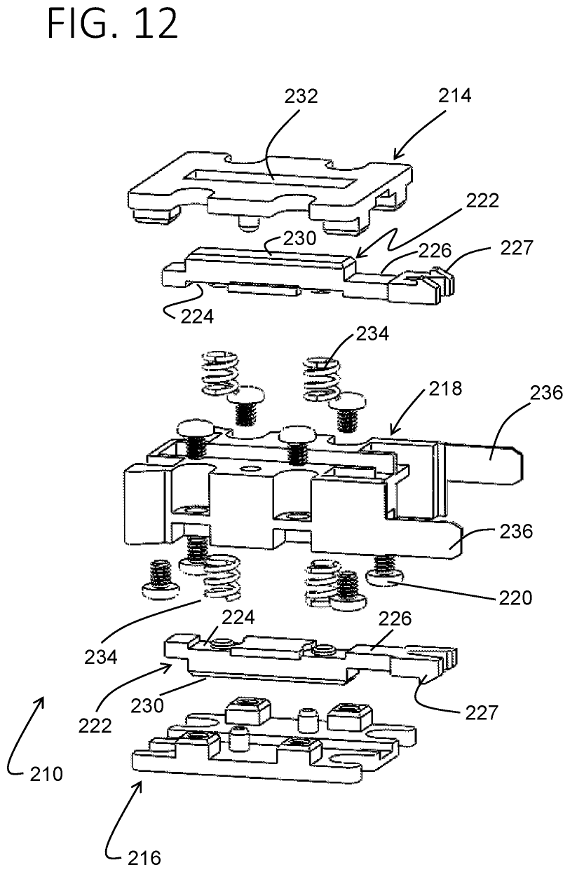

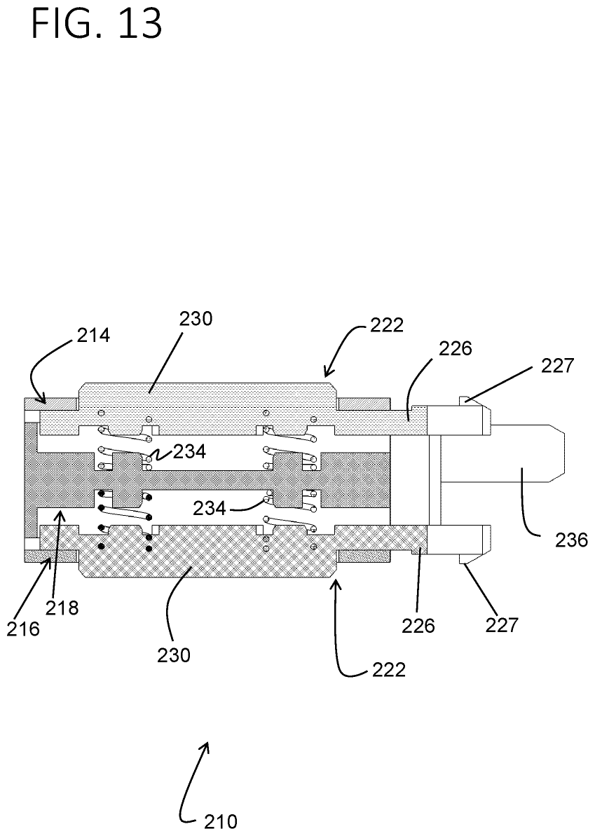

Referring now to FIGS. 11 and 12, an exemplary embodiment of a cap removal tool in accordance with the present disclosure is generally indicated at reference number 210. The cap removal tool 210 is broadly configured for removing the polarity cap 14 from the first end portion of the adapter housing 12 of the fiber optic adapter 10 for switching the polarity of the reversible polarity ports 16. The cap removal tool comprises a tool body 212 made up of a top portion 214, a bottom portion 216, and a central portion 218 sandwiched between the top and bottom portions. In the illustrated embodiment, the top portion 214, bottom portion 216, and central portion 218 are formed from separate pieces of material that are secured together by screws 220. The central piece 218 defines opposite first and second side portions of the tool body 212 extending between the top portion 214 and the bottom portion 216.

Depressible hook elements 222 are captured between the central portion 218 and each of the top portion 214 and the bottom portion 216. Each hook element 222 comprises a proximal portion 224 and a distal hook arm 226 configured to extend longitudinally outward from the tool body 212. Each hook arm 226 has a free end portion defining a removal hook 227 configured to hook onto the inward facing internal ledge 64 of the polarity cap 14, as will be described in further detail below.

Each proximal portion 224 is sandwiched between the central portion 218 and a respective one of the top portion 214 and the bottom portion 216. Each proximal portion 224 includes a push button boss 230 shaped and arranged for protruding through a push button opening 232 in a respective one of the top portion 214 and the bottom portion 216. In the illustrated embodiment, compression springs 234 are loaded between the proximal portion 224 of each depressible hook element 222 and the central portion 218 of the tool body 212. The compression springs 234 yieldably bias the depressible hook elements 222 outward toward the respective one of the top portion 214 and the bottom portion 216. Accordingly, each hook element 222 (including the distal hook arm 226 thereof) is movable in relation to the tool body 212 between an outer (hooking) position and a central (release) position. More particularly, a user can press the push button bosses 230 to depress the hook elements 222 so that they move toward one another.

First and second actuation arms 236 extend longitudinally from the side portions of the tool body 212. In the illustrated embodiment, the actuation arms 236 are integrally formed with the central portion piece 218. The actuation arms 236 are configured for insertion into channels defined by the grooves 52 of the polarity cap 14. Upon insertion, the actuation arms 236 function as actuation elements to bend bendable catches 34 inward and thereby unlatch the polarity cap from the adapter housing 12.

Exemplary methods of using the cap removal tool 210 and the reversible polarity adapter 10 will now be described in reference to the drawings. FIG. 14 depicts the cap removal tool 210 positioned for being advanced onto the adapter 10. In FIG. 14 the polarity cap 14 is installed on the adapter housing 12 in a first adapter polarity orientation (top-up).

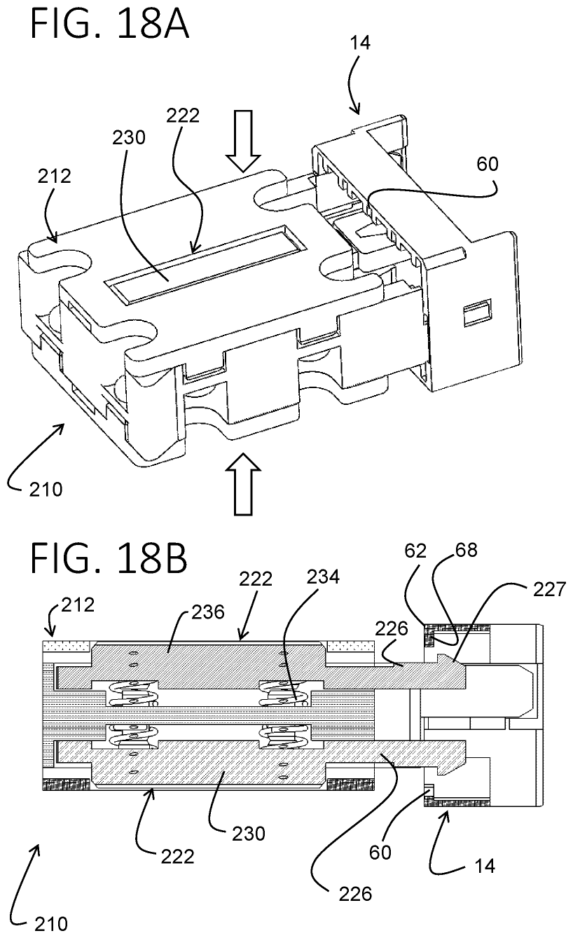

As shown in FIGS. 18A-18B, to operatively engage the cap removal tool 210 with the installed polarity cap 14, the user first presses the push button bosses 230 inward. This moves the hook elements 222 inward so that the hooks 227 can clear the lips 60, 62 of the polarity cap.

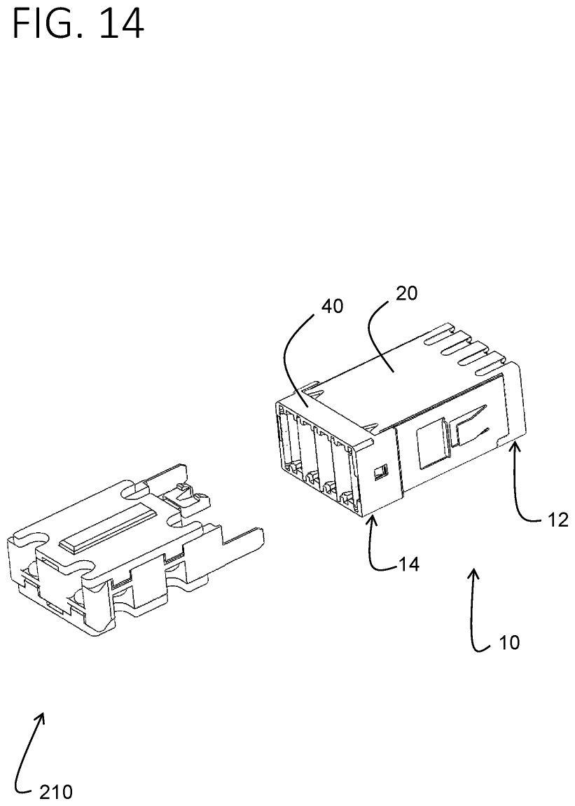

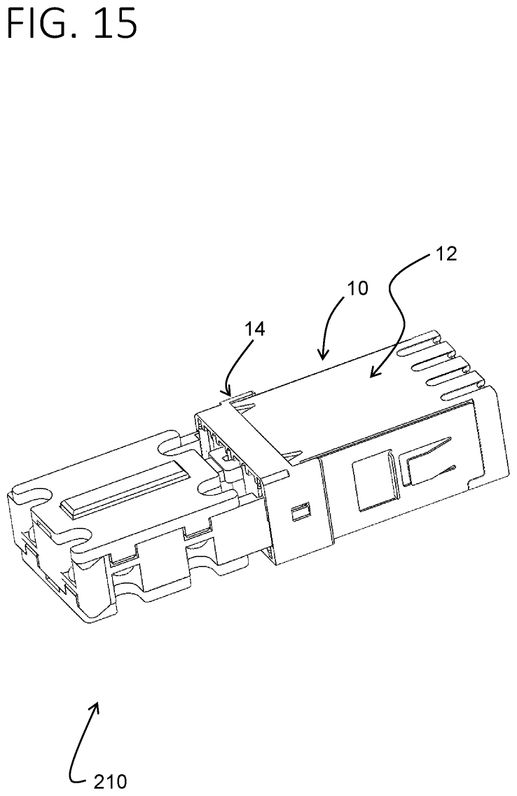

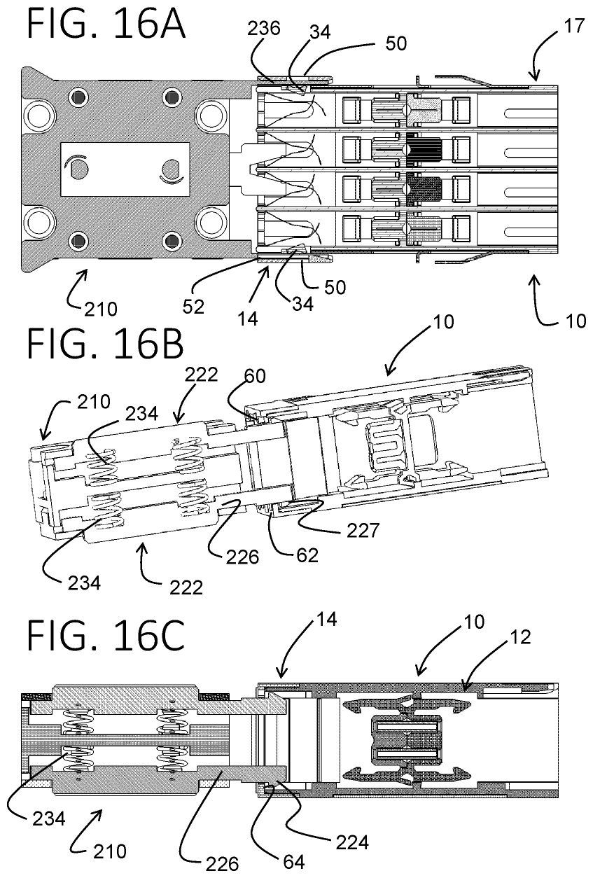

As shown in FIG. 16A, the removal tool 210 can be advanced forward into engagement with the first end portion of the adapter 10. The actuation arms 236 will slide into the channels defined by the grooves 52 of the polarity cap 14 alongside the side walls 24 of the adapter housing 12. As the actuation arms 236 move into the channels, they engage and deflect the bendable latch arms 34 such that they unlatch from the latch recesses 50 of the polarity cap 144. As shown in FIGS. 16B-16C, once the hooks 227 clear the lips 60, 62 of the polarity cap 14, the user can release the push-button bosses 230. The springs 234 drive the hook elements 222 outward until the removal hook 227 of at least one of the hook arms 226 hooks onto the inward facing internal ledge 64 of the polarity cap 14 (FIG. 16C). This operatively engages the cap removal tool 210 with the polarity cap 14.

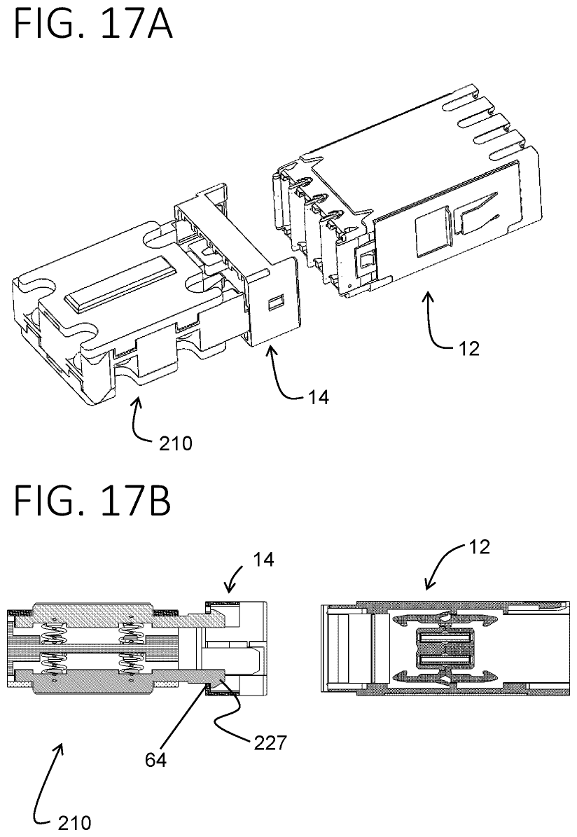

As shown in FIGS. 17A-17B, once the cap removal tool 210 is operatively engaged with the polarity cap 14, the tool 210 is pulled away from the adapter housing 12. Each hook 227 that opposes an internal ledge 64 bears on the internal ledge so that the polarity cap moves with the cap removal tool 210 as the cap removal tool is pulled away from the adapter housing 12. This separates the polarity cap 14 from the adapter housing 12.

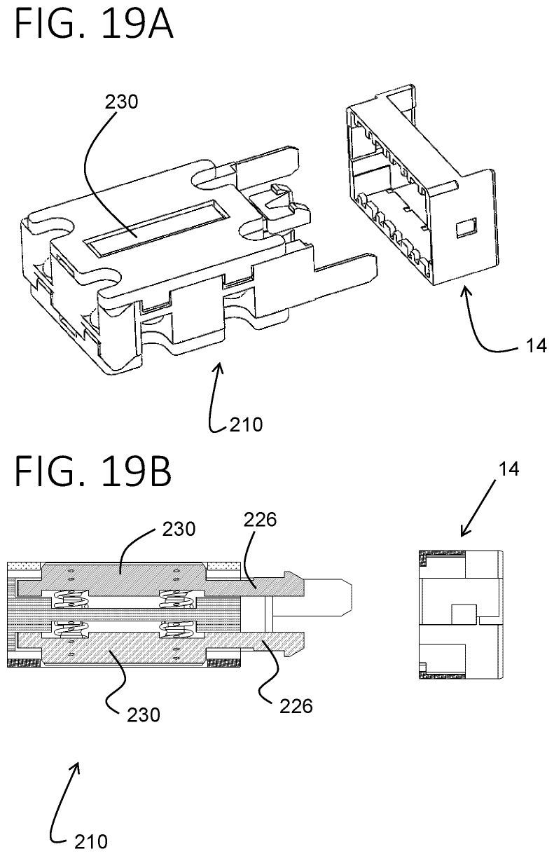

As shown in FIGS. 18A-19B, the cap removal tool 210 is then separated from the polarity cap 14 by pressing the push-button bosses inward 230 and withdrawing the hook arms 226 from the interior of the polarity cap.

Referring again to FIGS. 7A-7C, when the polarity cap 14 has been removed from the adapter housing 12 and separated from the tool 210, it can be inverted to an inverted orientation and installed on the first end portion of the adapter housing in the inverted orientation to change the polarity of the reversible polarity adapter ports 16. The steps of inverting the polarity cap 14 and installing it in the inverted orientation can be performed by hand without use of the tool 210.

In view of the foregoing, it can be seen that the adapter 10 and cap removal tool 210 enable switching the polarity of an adapter (e.g., a VSFF adapter) in a quick and straightforward manner.

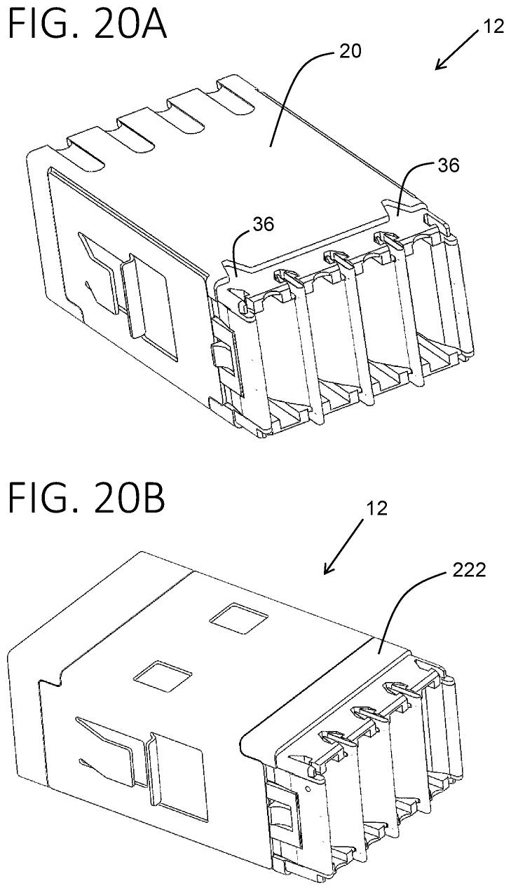

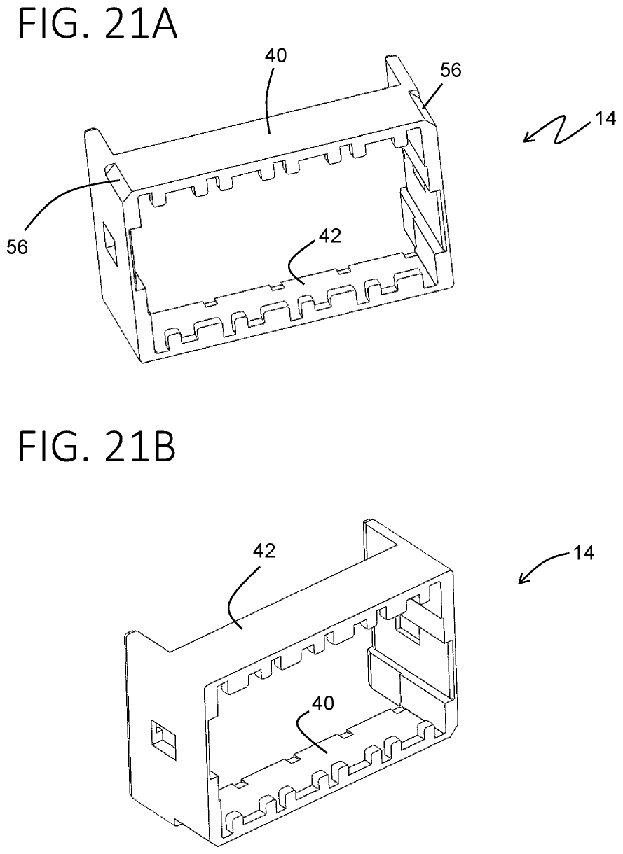

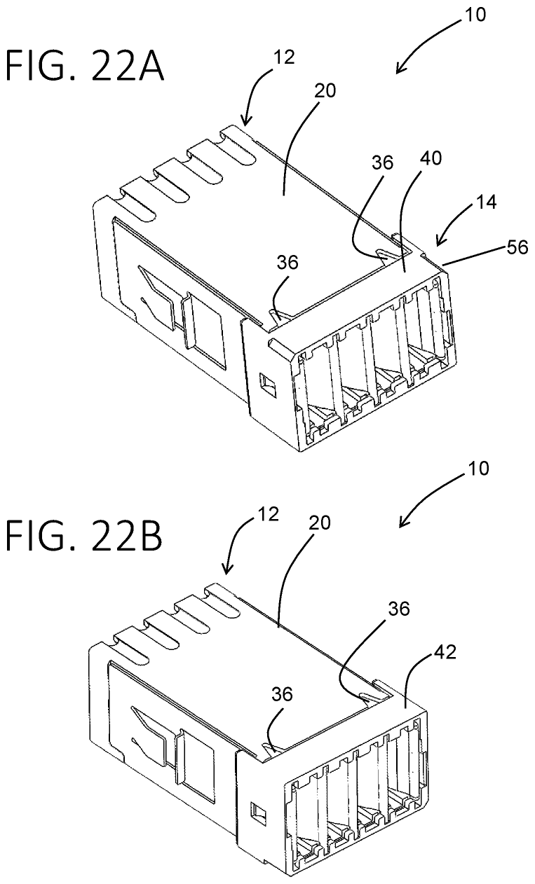

FIGS. 20A-20B illustrate how the indicator formations 36 provide the top wall 20 of the adapter housing 12 with a distinct visual appearance near the first end portion of the adapter housing 12. FIGS. 21A-21B show how the indicator formations 56 provide the top wall 40 of the cap with a distinct visual appearance from the bottom wall 42. FIG. 22A shows the visual impression created at the first end portion of the adapter 10 by the indicator formations 36, 56 when the polarity cap 14 is installed on the adapter housing 12 in the first adapter polarity orientation (top-up) (which means that the adapter 10 is configured in the first-first polarity configuration). By contrast, FIG. 22B shows the visual impression created at the first end portion of the adapter 10 by the indicator formations 36 and cap bottom wall 42 when the polarity cap 14 is installed on the adapter housing 12 in the second adapter polarity orientation (bottom-up) (which means that the adapter 10 is configured in the first-second polarity configuration). As can be seen by comparing FIGS. 22A and 22B, the indicator formations 36, 56 provide a clear visual marking by which a user can determine whether the adapter 10 is in a first-first polarity configuration or a first-second polarity configuration.

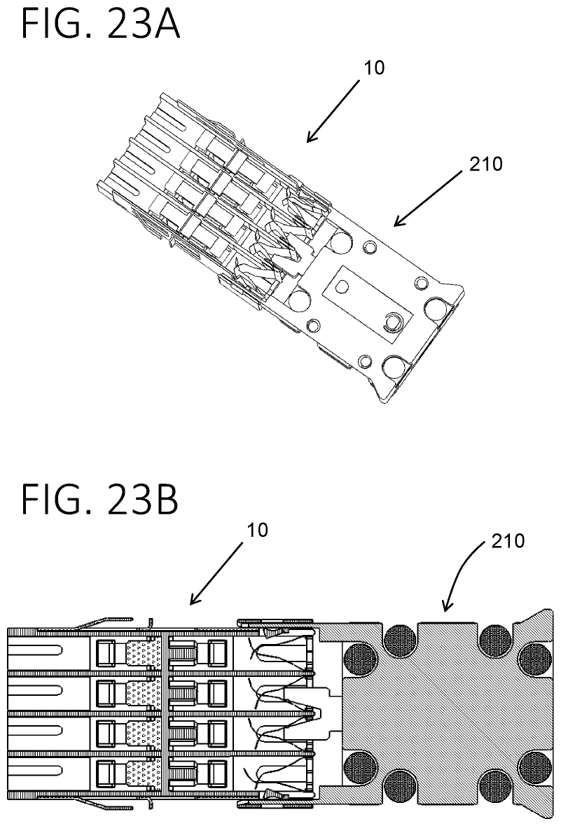

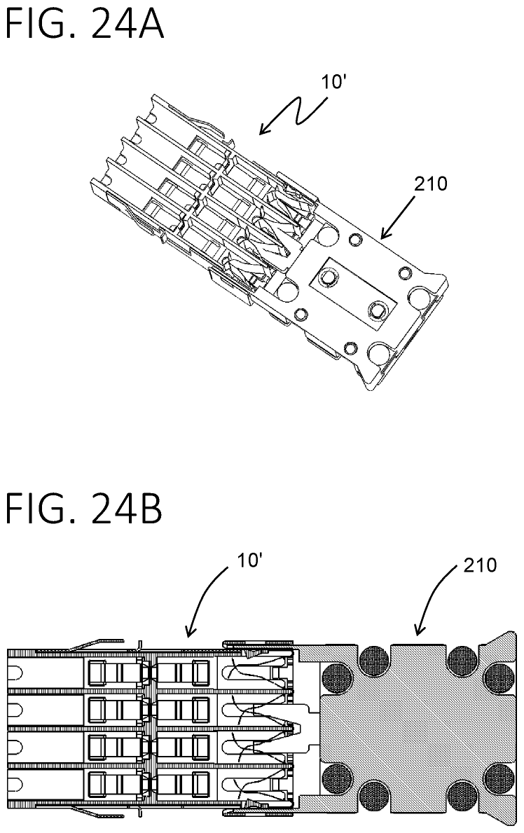

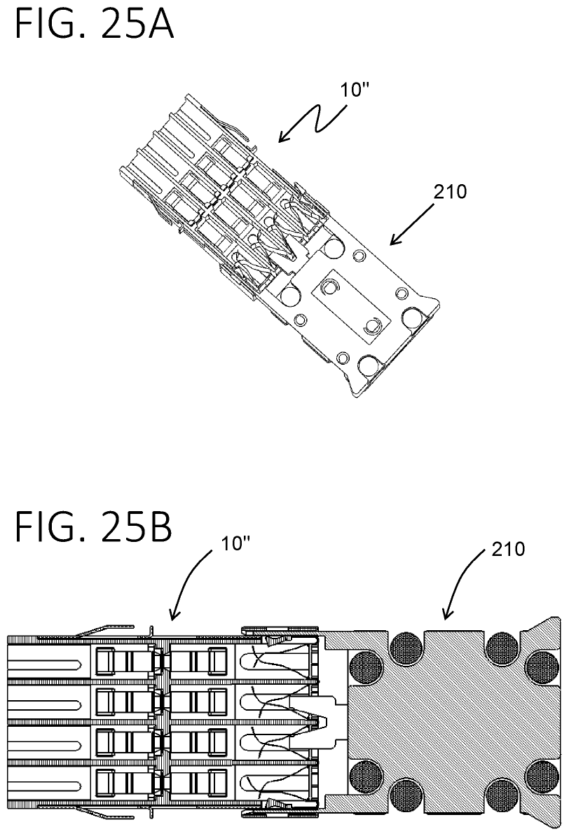

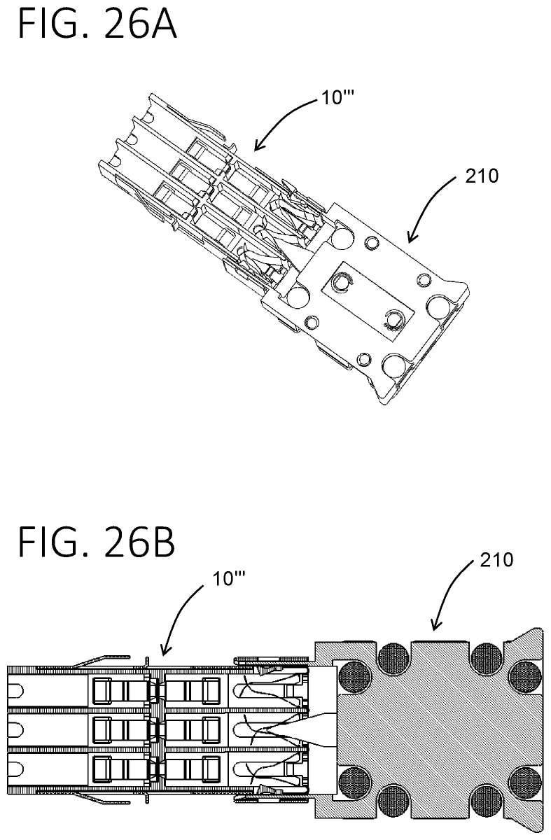

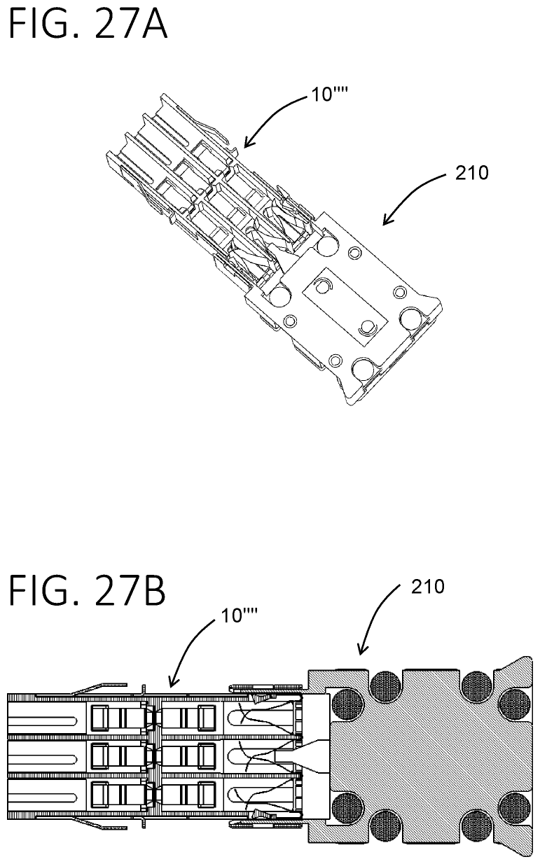

The principles of the present disclosure can be adapted for use with many different types of fiber optic adapters. Without limitation, FIGS. 23A-23B show an example in which the adapter 10 is an SN quad adapter; FIGS. 24A-24B show an example in which the adapter 10′ is an SN-MT 8-fiber quad adapter; FIGS. 25A-25B show an example in which the adapter 10″ is an SN-MT 16-fiber quad adapter; FIGS. 26A-26B show an example in which the adapter 10′″ is an SN-MT 8-fiber triplex adapter; and FIGS. 27A-27B show an example in which the adapter 10″″ is an SN-MT 16-fiber triplex adapter. The principles of the present disclosure may also be adapted for other types of adapters besides the ones illustrated (e.g., other VSFF adapters, such as MDC and MMC adapters).

Having described the disclosure in detail, it will be apparent that modifications and variations are possible without departing from the scope of the disclosure defined in the appended claims.

When introducing elements of the present disclosure or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the disclosure are achieved and other advantageous results attained.

As various changes could be made in the above constructions, products, and methods without departing from the scope of the disclosure, it is intended that all matter contained in the above description and shown in the accompanying drawings shall be interpreted as illustrative and not in a limiting sense.

1. A fiber optic adapter comprising:
an adapter housing having a first end portion and a second end portion spaced apart along a longitudinal axis, the adapter housing defining at least one connector port opening through the first end portion of the adapter housing for mating with a fiber optic connector in either of a first connector polarity orientation or a second connector polarity orientation; and
a polarity cap releasably securable to the first end portion of the adapter housing in either of a first adapter polarity orientation or a second adapter polarity orientation, wherein when the polarity cap is secured to the first end portion of the adapter housing in the first adapter polarity orientation, the polarity cap permits the fiber optic connector to mate with the connector port in the first connector polarity orientation but blocks the fiber optic connector from mating with the connector port in the second connector polarity orientation, and wherein when the polarity cap is secured to the first end portion of the adapter housing in the second adapter polarity orientation, the polarity cap permits the fiber optic connector to mate with the connector port in the second connector polarity orientation but blocks the fiber optic connector from mating with the connector port in the first connector polarity orientation.

2. The fiber optic adapter as set forth in claim 1, wherein the polarity cap comprises a nominal top wall, a nominal bottom wall, and a height extending from the nominal top wall to the nominal bottom wall, the nominal top wall and the nominal bottom wall having different internal shapes thereby defining a polarity of the polarity cap.

3. The fiber optic adapter as set forth in claim 2, wherein the nominal top wall defines a first keyway for each reversible polarity connector port and the nominal bottom wall defining a second keyway for each connector port, each first keyway differing from the respective second keyway in at least one of (i) width and (ii) widthwise position.

4. The fiber optic adapter as set forth in claim 2, wherein the polarity cap comprises opposite first and second cap side walls, each of the first and second cap side walls defining a respective latch feature for latching with the adapter housing to secure the polarity cap to the first end portion of the adapter housing in either of the first adapter polarity orientation and the second adapter polarity orientation.

5. The fiber optic adapter as set forth in claim 4, wherein latch features of the first and second cap side walls comprise latch recesses, the adapter housing comprising first and second adapter side walls defining resiliently bendable catches configured to snap into the latch recesses when the polarity cap is secured to the first end portion of the adapter housing in either of the first adapter polarity orientation and the second adapter polarity orientation.

6. The fiber optic adapter as set forth in claim 5, wherein each of the first and second cap side walls is configured to define channel beside a respective one of the first and second adapter side walls when the polarity cap is secured to the first end portion of the adapter housing in either of the first adapter polarity orientation and the second adapter polarity orientation, each channel receiving one of the bendable catches therein, the channels being sized and arranged to accept actuation elements of a cap removal tool whereby the actuation elements resiliently bend the bendable catches to unlatch the polarity cap from the adapter housing.

7. The fiber optic adapter as set forth in claim 6, wherein at least one of the nominal top wall and the nominal bottom wall defines an inward facing internal ledge configured operatively engage a removal hook of the cap removal tool so that the removal tool can pull the cap off of the adapter housing via the removal hook.

8. The fiber optic adapter as set forth in claim 2, wherein the nominal top wall and the nominal bottom wall have different external shapes.

9. The fiber optic adapter as set forth in claim 8, wherein the adapter housing comprises an adapter top wall and an adapter bottom wall, the adapter top wall and the adapter bottom wall having different external shapes.

10. The fiber optic adapter as set forth in claim 1, wherein further comprises three connector ports arranged side-by-side in the adapter housing.

11. The fiber optic adapter as set forth in claim 1, wherein the adapter housing defines at least one fixed port opening through the second end portion of the adapter housing for mating with a fiber optic connector in the first connector polarity orientation.

12. The fiber optic adapter as set forth in claim 11, wherein:
securing the polarity cap to the first end portion of the adapter housing in the first adapter polarity orientation configures the fiber optic adapter in a first-first polarity configuration wherein the fiber optic adapter is configured to make an optical connection between a first fiber optic connector mated with each fixed polarity connector port in the first connector polarity orientation and a second fiber optic connector mated with each connector port in the first connector polarity orientation; and
securing the polarity cap to the first end portion of the adapter housing in the second polarity orientation configures the fiber optic adapter in a first-second polarity configuration wherein the fiber optic adapter is configured to make an optical connection between a first fiber optic connector mated with each fixed polarity connector port in the first connector polarity orientation and a second fiber optic connector mated with each connector port in the second connector polarity orientation.

13. The fiber optic adapter as set forth in claim 11, wherein the adapter housing comprises an external formation adjacent the first end portion of the adapter housing to indicate an orientation of the fixed polarity connector port, and the polarity cap comprises one or more indicator formations indicating which is the nominal top wall and which is the nominal bottom wall of the polarity cap.

14. The fiber optic adapter as set forth in claim 1, wherein the polarity cap is painted with different colors to indicate the first and second adapter polarity orientations, respectively.

15. A method of changing polarity of a fiber optic adapter, the method comprising:
removing a polarity cap from a first end portion of an adapter housing;
inverting the polarity cap to an inverted orientation in relation to the adapter housing; and
installing the polarity cap on the first end portion of the adapter housing in the inverted orientation.

16. The method of claim 15, wherein said removing a polarity cap comprises using a cap removal tool to unlatch the polarity cap from the adapter housing.

17. The method of claim 16, wherein said removing a polarity cap further comprises using a hook of the cap removal tool to pull the polarity cap off of the adapter housing.
